(19) United States
(12) Patent Application Publication
(10) Pub. No.: US 2026/0087483 A1
(43) Pub. Date: Mar. 26, 2026

(54) INITIATING BLOCKCHAIN MESSAGES USING NEAR FIELD COMMUNICATION

(71) Applicant: Coinbase, Inc., Oakland, CA (US)

(72) Inventors: Arjun Dureja, Mississauga (CA); Amhed Herrera, Austin, TX (US); Justin Douglas Lee, Quincy, MA (US); Jiong Shen, Milpitas, CA (US); Chintan Turakhia, Piedmont, CA (US)

(21) Appl. No.: 18/895,346

(22) Filed: Sep. 24, 2024

(51) Int. Cl. G06Q 20/32; G06Q 20/02; G06Q 20/40

(52) U.S. Cl. CPC G06Q 20/3278; G06Q 20/02; G06Q 20/4014

(57) ABSTRACT

Methods, systems, and devices for data management are described. Techniques described herein may enable a receiving device to transmit a near-field communication (NFC) signal that requests for a user device to broadcast a transaction on a blockchain network. The signal may indicate one or more features of the transaction, such as an amount of crypto token to transfer, one or more goods or services that are being paid for via the transaction, an account to which the user device may transfer the crypto token, and the like. The user device may accordingly launch an application and may prompt the user to provide a user input to trigger the user device to broadcast the requested transaction via the blockchain network. In some examples, the application may display information associated with the transaction.

### FIELD OF TECHNOLOGY

The present disclosure relates generally to data management, including techniques for initiating blockchain messages using near field communication (NFC).

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports initiating blockchain messages using near field communication (NFC) in accordance with aspects of the present disclosure.

FIG. 2 shows an example of a user interface (UI) diagram that supports initiating blockchain messages using NFC in accordance with aspects of the present disclosure.

FIG. 3 shows an example of a block diagram that supports initiating blockchain messages using NFC in accordance with aspects of the present disclosure.

FIG. 4 shows an example of a process flow that supports initiating blockchain messages using NFC in accordance with aspects of the present disclosure.

FIG. 5 shows a block diagram of an apparatus that supports initiating blockchain messages using NFC in accordance with aspects of the present disclosure.

FIG. 6 shows a block diagram of a client application that supports initiating blockchain messages using NFC in accordance with aspects of the present disclosure.

FIG. 7 shows a diagram of a system including a device that supports initiating blockchain messages using NFC in accordance with aspects of the present disclosure.

FIGS. 8 and 9 show flowcharts illustrating methods that support initiating blockchain messages using NFC in accordance with aspects of the present disclosure.

### DETAILED DESCRIPTION

A blockchain wallet application (e.g., blockchain address application) may desire to purchase goods or services using a crypto token stored at a blockchain address of the blockchain wallet application. In some examples, to perform transactions with other types of currency (e.g., currency that is not associated with a blockchain network), the user may use contactless payment (e.g., “tap-to-pay”) by transmitting a signal from a user device to a receiving device (e.g., a device receiving the payment, such as a point-of-sale (POS) system) that indicates information (e.g., credit card information, banking information) that may enable the receiving device to initiate and perform the transaction. However, for crypto-based transactions, the receiving device may not initiate the transfer. That is, for a transaction to occur on the blockchain network, the user device may initiate the transaction (e.g., rather than the receiving device). Some contactless payment techniques for other types of transactions may therefore not be used for crypto-based contactless payment.

Accordingly, techniques described herein may enable crypto-based contactless payment (e.g., “tap-to-pay’). For example, the receiving device may transmit a signal (e.g., a near-field communication (NFC) signal) that requests for the user device to broadcast a transaction on the blockchain network. The signal may indicate one or more features of the transaction (e.g., via a deep link), such as an amount of crypto token to transfer, one or more goods or services that are being paid for via the contactless payment, a blockchain address to which the user device may transfer the crypto token, and the like. A deep link may be an example of a customized uniform resource locator (URL) that is configured to direct users to a specific page within an application (e.g., a blockchain wallet application). The user device may accordingly launch an application (e.g., in response to a user input) such as an application associated with the custodial token platform, and may prompt the user to provide a user input (e.g., an authentication) to trigger the user device to broadcast the requested transaction via the blockchain network. In some examples, the application may display information associated with the transaction, such as the amount of crypto to transfer, the address to which the user device may transfer the crypto token, an account from which the user device may transfer the crypto token, and the like.

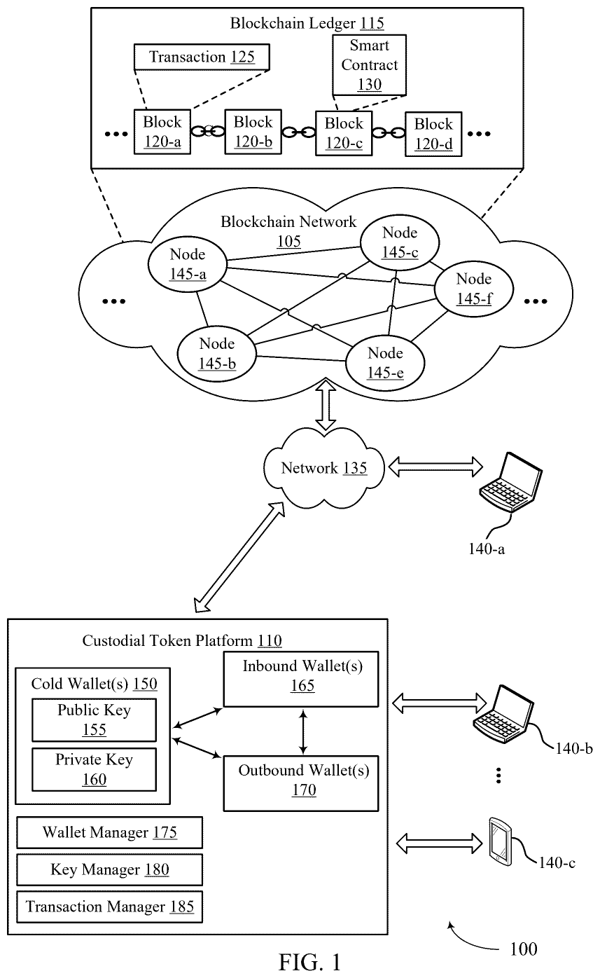

FIG. 1 illustrates an example of a computing environment 100 that supports initiating blockchain messages using NFC in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet”and “address”may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some examples of the system 100, a user of a user device 140 that includes a blockchain wallet application may perform a transaction using contactless payment techniques. For example, a receiving device (e.g., device receiving the payment, such as a POS system) may transmit a signal (e.g., a NFC signal) that requests for the user device 140 to broadcast a transaction on the blockchain network. The signal may indicate one or more features of the transaction (e.g., via a deep link), such as an amount of crypto to transfer, one or more goods or services that are being paid for via the contactless payment, an account (e.g., blockchain address) to which the user device 140 may transfer the token, and the like. The user device 140 may accordingly launch an application (e.g., in response to a user input) such as a blockchain wallet application, and may prompt the user to provide a user input (e.g., an authentication) to trigger the user device 140 to broadcast the requested transaction via the blockchain network. In some examples, the application may display information associated with the transaction, such as the amount of crypto to transfer, the account to which the user device 140 may transfer the token, an account from which the user device 140 may transfer the token, and the like.

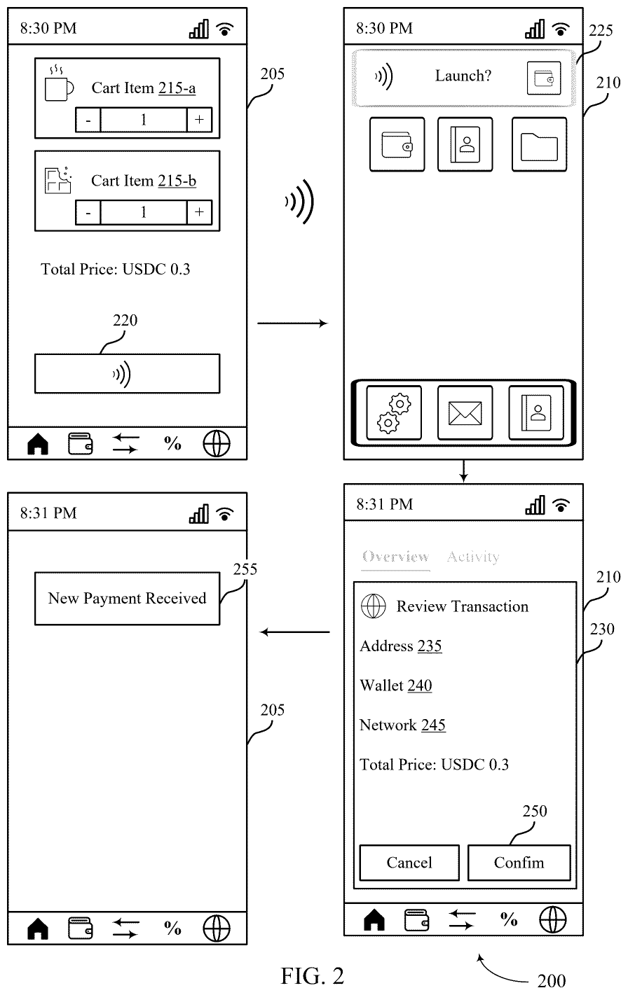

FIG. 2 shows an example of a UI diagram 200 that supports initiating blockchain messages using NFC in accordance with aspects of the present disclosure. The UI diagram 200 may implement or may be implemented by aspects of the system 100. For example, the UI diagram 200 may be implemented by a user device 210 and a receiving device 205 (e.g., another user device, a POS system), which may be examples of the corresponding devices as described with reference to FIG. 1.

In some examples, a user of a user device 210 (e.g., a device with an Android or iOS operating system) may perform a contactless payment transaction to transfer an amount of crypto token from a blockchain address associated with the user (e.g., a blockchain address associated with a blockchain address application on the user device 210) to a blockchain address associated with a merchant. In some examples, the merchant may use a receiving device 205 (e.g., a device associated with the blockchain address associated with the merchant that may receive the amount of crypto token, a POS system, a device with an Android operating system) to initiate the contactless payment transaction. For example, the receiving device 205 may receive an input from the merchant or from the user (e.g., selection of a button 220) that triggers the receiving device 205 to transmit an NFC signal to the user device 210 (e.g., via host card emulation (HCE)).

The NFC signal may indicate plaintext information about the transaction (e.g., information about a blockchain message requested to be broadcast by the user device 210) to the user device 210. For example, the NFC signal may indicate the blockchain address (e.g., an identifier of the blockchain address) associated with the merchant, an amount of crypto to be transferred (e.g., a total price), order information such as an indication of one or more products being purchased via the transaction (e.g., a cart associated with the transaction, including a cart item 215-a and a cart item 215-b), a chain identifier, and the like. In some examples, the NFC signal may indicate a deep link to the user device 210. The user device 210 may access the deep link to obtain the information about the transaction. In some examples (e.g., if the receiving device 205 has an iOS operating system), the receiving device may display a Quick Response (QR) code in response to the input (e.g., rather than transmitting the NFC signal).

The user device 210 may display, in response to detecting the NFC signal (e.g., or scanning the QR code), a prompt 225 for the user to provide a first user input. For example, the prompt 225 may request for the user to launch the blockchain address application, or for the user to connect to a virtual private network (VPN) for which crypto transactions may be supported and to download the blockchain address application to the user device 210 (e.g., if the blockchain address application is not currently downloaded to the user device 210). The user device 210 may launch (e.g., or download and launch) the blockchain address application in response to receiving the first user input (e.g., a selection on a GUI of the user device 210).

In some examples, the user device may determine, via the blockchain address application, whether the blockchain address associated with the user includes sufficient funds (e.g., an amount of crypto token that is greater than or equal to the total price indicated via the NFC signal). If the blockchain address associated with the user does not include sufficient funds (e.g., if the blockchain address includes no crypto token or an amount of crypto token that is less than the total price), the blockchain address application may prompt the user to purchase additional funds. For example, the blockchain address application may instruct the user to purchase an amount of crypto token such that a balance of the blockchain address associated with the user is at least the total price indicated via the NFC signal.

The blockchain address application may compose the blockchain transaction and display (e.g., via payment tray on a user interface of the blockchain address application) information 230 about the transaction and a prompt 250 requesting a second user input (e.g., a signature). The information 230 may include an indication of the blockchain address 235 associated with the merchant, a wallet 240 (e.g., the blockchain address associated with the user), the total price, a network identifier 245, and the like. The information 230 may include information indicated via the NFC signal (e.g., via the deep link), additional information requested from the receiving device 205 by the user device 210, and the like.

The user may provide the second user input to the user device 210. For example, the user may select a button displayed via the blockchain address application to confirm the transaction, a button displayed via the blockchain address application to cancel the transaction, one or more biometric authentication factors (e.g., a fingerprint identifier, a face identifier, or another biometric authentication factor and/or a password or personal identification number) to authorize the transaction, and the like. In response to receiving the second user input (e.g., a confirmation and/or authorization for the transaction), the user device 210 may transmit one or more communications that causes the requested blockchain message to be broadcast to a blockchain network (e.g., and accordingly cause the amount of crypto token to be transferred from the wallet 240 to the blockchain address 235 associated with the merchant). The user device 210 may close the information 230 after receiving the second user input and/or completing the transaction.

In some examples, following a successful broadcast of the requested blockchain message, the user device 210 and/or the receiving device 205 may display a confirmation message 255 to the user and/or the merchant, or may provide haptic feedback indicating that the transaction is successful. In some examples, the user device 210 may transmit a configuration message to the receiving device 205 confirming successful transfer of the amount of crypto token from the wallet 240 to the blockchain address 235 associated with the merchant. The receiving device 205 may close a flow associated with the transaction upon confirmation of success of the transaction.

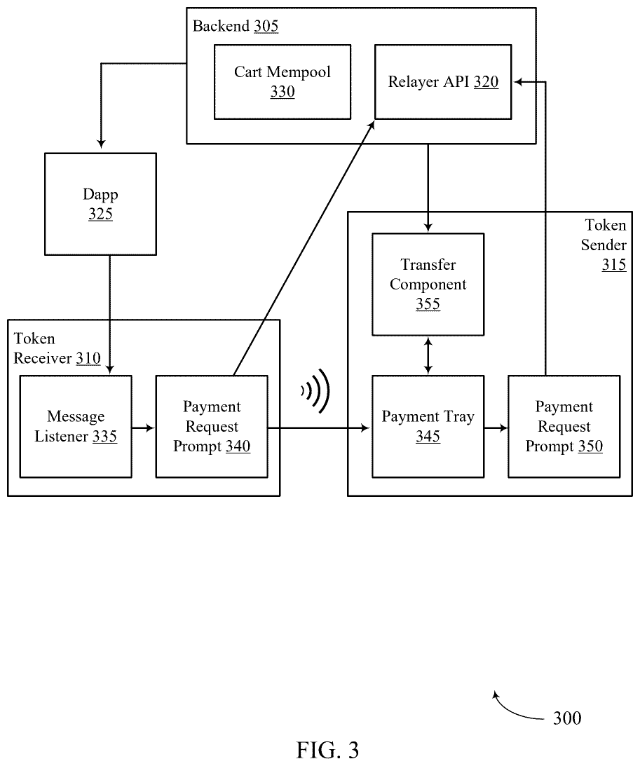

FIG. 3 shows an example of a block diagram 300 that supports initiating blockchain messages using NFC in accordance with aspects of the present disclosure. The block diagram 300 may implement or may be implemented by aspects of the system 100 or the UI diagram 200. For example, the block diagram 300 may be implemented by a user device, which may be an example of a user device 140 as described with reference to FIG. 1.

In some examples, the block diagram 300 may include a backend 305, a token receives 310, and a token sender 315 that may be configured to perform NFC-initiated blockchain transactions as described herein. For example, the token receiver 310 may be an example of a receiving device (e.g., a POS system) associated with a blockchain address that may receive a crypto token from a blockchain address associated with the token sender 315, which may be an example of a user device.

In some examples, the backend 305 (e.g., a backend associated with a relayer application programming interface (API) 320 may generate a data object (e.g., a JavaScript Object Notation (JSON) object) representing a current session for the transaction. The data object may include information associated with the transaction, such as cart data (e.g., an amount of crypto token to transfer, the blockchain account to which the crypto token may be transferred, one or more goods or services that are being paid for via the transaction). For example, a user may cause the backend 305 to generate the data object in response to initiating a check-out procedure for the transaction. The relayer API 320 may obtain the data object from the Dapp 325. The relayer API 320 may obtain a universally unique identifier (UUID) for the transaction and the backend 305 may provide the UUID to a Dapp 325 via a cart mempool 330. In some examples, the Dapp 325 and the backend 305 may be third-party components (e.g., unaffiliated with the token sender 315 and the token receiver 310).

The token receiver 310 may obtain the UUID, the data object, and/or a request for the token receiver 310 to initiate the transaction from the Dapp 325 (e.g., via a message listener 335). In some examples, the UUID may be ephemeral. For example, the UUID may be unassociated with the transaction after a period of time (e.g., 5 minutes). The token receiver may generate an NFC signal via a payment request prompt 340 that provides information related to the transaction to the token sender 315 (e.g., via a payment tray 345). The information related to the transaction may include the amount of crypto token to transfer, the blockchain account to which the crypto token may be transferred, a network identifier, and the like.

The payment tray 345 may prompt the token sender 315 to obtain a user input (e.g., an authorization for the transaction) via a payment request prompt 350. The payment request prompt 350 may provide the authorization for the transaction to the backend 305. The backend 305 may accordingly obtain a payload for the transaction (e.g., information related to the transaction, such as a cart payload associated with the UUID). For example, the relayer API 320 may receive the information from the token receiver 310 may provide the payload to a transfer component 355 which may compose the transfer of the requested amount of crypto token (e.g., provided by the payment tray 345). The token sender 315 may accordingly perform the transaction to send the requested amount of crypto token from the blockchain address associated with the token sender 315 to the blockchain address associated with the token receiver 310.

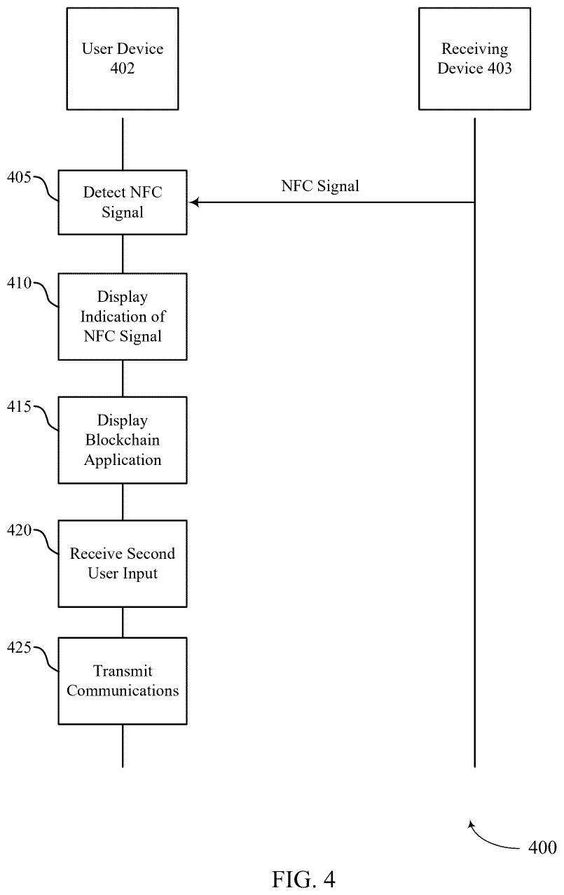

FIG. 4 shows an example of a process flow 400 that supports initiating blockchain messages using NFC in accordance with aspects of the present disclosure. The process flow 400 may implement or may be implemented by aspects of the system 100, the UI diagram 200 or the block diagram 300. For example, the process flow 400 may be implemented by a user device 402 and a receiving device 403 (e.g., another user device, a POS system), which may be examples of the corresponding devices as described with reference to FIG. 1.

In the following description of the process flow 400, the operations between the user device 402 and the receiving device 403 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At 405, the user device 402 may detect a signal (e.g., an NFC signal) from the receiving device 403. The signal may include an indication of a blockchain message configured to transfer an amount of crypto token from a blockchain address associated with a user of the user device 402 to a blockchain address associated with the receiving device 403. In some examples, the signal may indicate the amount of the crypto token, an indication of one or more products associated with the blockchain message, an indication of the blockchain address associated with the receiving device, and/or a chain identifier associated with the blockchain message. In some examples, the signal may indicate a deep link that is used to obtain the indication of the blockchain message. The user device 402 may not transmit the signal.

In some examples, the user device 402 may transfer a request to obtain information associated with the blockchain message. The user device 402 may receive, from the receiving device 403, the information associated with the blockchain message and/or the deep link that is used to obtain the indication of the blockchain message in response to the request. In some examples, the receiving device 403 may indicate the information associated with the blockchain message to another device (e.g., a backend).

At 410, the user device 402 may display an indication of the NFC signal. For example, the user device 402 may display a message that informs the user of reception of the NFC signal. The message may prompt the user to provide a first user input. For example, the message may prompt the user to provide an instruction to launch a blockchain address application associated with the blockchain address associated with the user device 402 (e.g., an application associated with a custodial token platform). In some examples, the indication of the NFC signal may be a toast notification. In such examples, the first user input may activate the toast notification and cause display of the blockchain address application.

In some examples, the user device 402 may determine that the user does not have the blockchain address application installed on the user device 402. The user device 402 may accordingly trigger download of the blockchain address application. In some examples, if the user device 402 determines that an amount of crypto token stored in the blockchain address associated with the user device 402 is less than the amount of crypto token indicated via the signal, the user device 402 may accordingly prompt the user to purchase the crypto token (e.g., such that the blockchain address associated with the user device 402 has access to at least the amount of crypto token indicated via the signal).

At 415, the user device 402 may display the blockchain address application (e.g., in response to receiving the first user input). For example, the user device 402 may display the blockchain address application after downloading the blockchain address application, after the user purchases an amount of crypto token, or both. The blockchain address application may include a user interface displaying the information associated with the blockchain message (e.g., the amount of the crypto token, an indication of one or more products associated with the blockchain message, an indication of the blockchain address associated with the receiving device, an indication of the blockchain address associate with the user device 402, a network identifier associated with the blockchain message, and/or a chain identifier associated with the blockchain message). For example, the blockchain address application may display the information associated with the blockchain message based on identifying the deep link indicated via the signal and/or the information indicated via the message responsive to the request for the information associated with the blockchain message.

At 420, the user device 402 may receive a second user input. For example, the user device 402 may receive a password authentication, a biometric authentication, or another user input that authorizes the user device 402 to broadcast the blockchain message. The user may provide the second user input via the blockchain address application.

At 425, the user device 402 may transmit one or more communications (e.g., to a device or network that is different from the receiving device) that causes broadcast of the blockchain message via the blockchain network. The user device 402 may transmit the one or more communications in response to receiving the second user input. In some examples, broadcasting the blockchain message may cause transfer of the amount of crypto token from the blockchain address associated with the user device 402 to the blockchain address associated with the receiving device 403. In some examples, when the blockchain message is confirmed on the blockchain network, the user device 402 may transmit one or more messages to the receiving device 403 that confirm that the blockchain message is confirmed on the blockchain network.

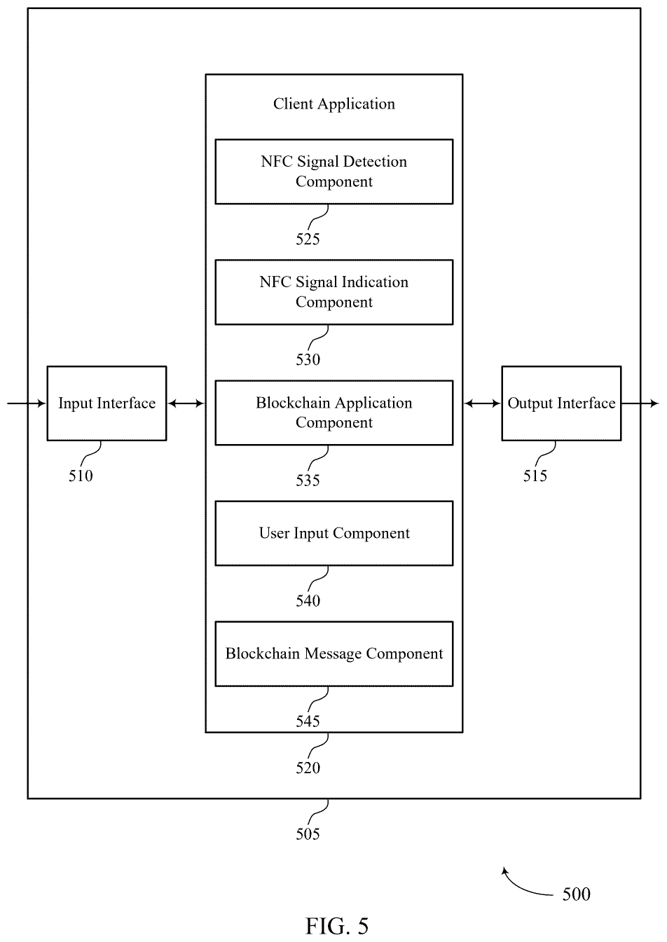

FIG. 5 shows a block diagram 500 of a device 505 that supports initiating blockchain messages using NFC in accordance with aspects of the present disclosure. The device 505 may include an input interface 510, an output interface 515, and a client application 520. The device 505, or one or more components of the device 505 (e.g., the input interface 510, the output interface 515, the client application 520), may include at least one processor, which may be coupled with at least one memory, to support the described techniques. Each of these components may be in communication with one another (e.g., via one or more buses).

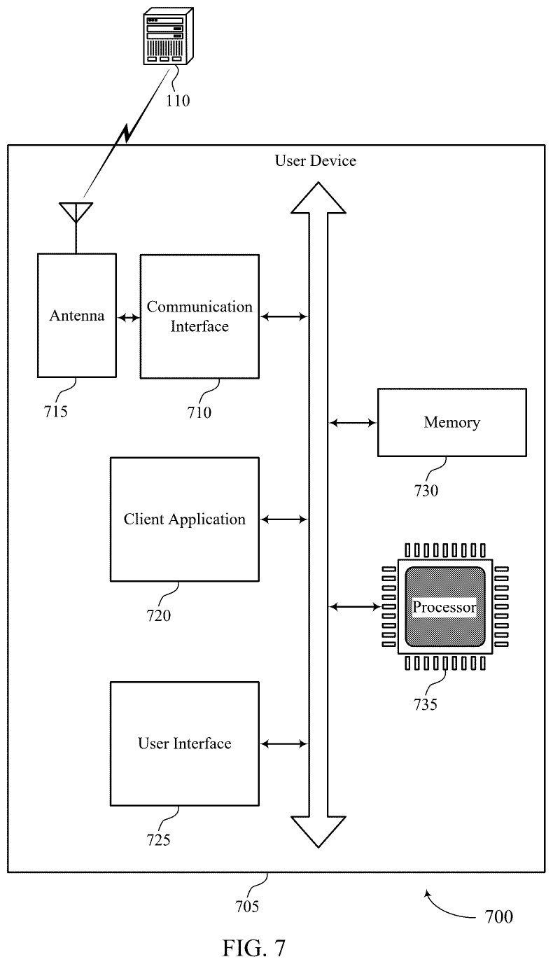

The input interface 510 may manage input signaling for the user device 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the user device 505 for processing. For example, the input interface 510 may transmit such corresponding signaling to the client application 520 to support initiating blockchain messages using NFC. In some cases, the input interface 510 may be a component of a 710 as described with reference to FIG. 7.

The output interface 515 may manage output signaling for the user device 505. For example, the output interface 515 may receive signaling from other components of the user device 505, such as the client application 720, and may transmit such output signaling corresponding to (e.g., representative of or otherwise based on) such signaling to other systems or devices. In some cases, the output interface 515 may be a component of a user interface 725 as described with reference to FIG. 7.

For example, the client application 520 may include an NFC signal detection component 525, an NFC signal indication component 530, a blockchain application component 535, a user input component 540, a blockchain message component 545, or any combination thereof. In some examples, the client application 520, or various components thereof, may be configured to perform various operations (e.g., receiving, monitoring, transmitting) using or otherwise in cooperation with the input interface 510, the output interface 515, or both. For example, the client application 520 may receive information from the input interface 510, send information to the output interface 515, or be integrated in combination with the input interface 510, the output interface 515, or both to receive information, transmit information, or perform various other operations as described herein.

The client application 520 may support digital token management in accordance with examples as disclosed herein. The NFC signal detection component 525 may be configured as or otherwise support a means for detecting, at the user device, a NFC signal transmitted by a receiving device, wherein the NFC signal comprises an indication of a blockchain message configured to transfer, via a blockchain network, an amount of a crypto token to a blockchain address associated with the receiving device. The NFC signal indication component 530 may be configured as or otherwise support a means for displaying an indication of the NFC signal. The blockchain application component 535 may be configured as or otherwise support a means for displaying, based at least in part on receiving first user input associated with the NFC signal, a blockchain address application that comprises a user interface that displays information associated with the blockchain message. The user input component 540 may be configured as or otherwise support a means for receiving, at the blockchain address application, second user input indicating confirmation of the information associated with the blockchain message. The blockchain message component 545 may be configured as or otherwise support a means for transmitting, after receiving the second user input, one or more communications that causes broadcast of the blockchain message via the blockchain network, wherein broadcasting the blockchain message causes transfer of the amount of the crypto token to the blockchain address associated with the receiving device.

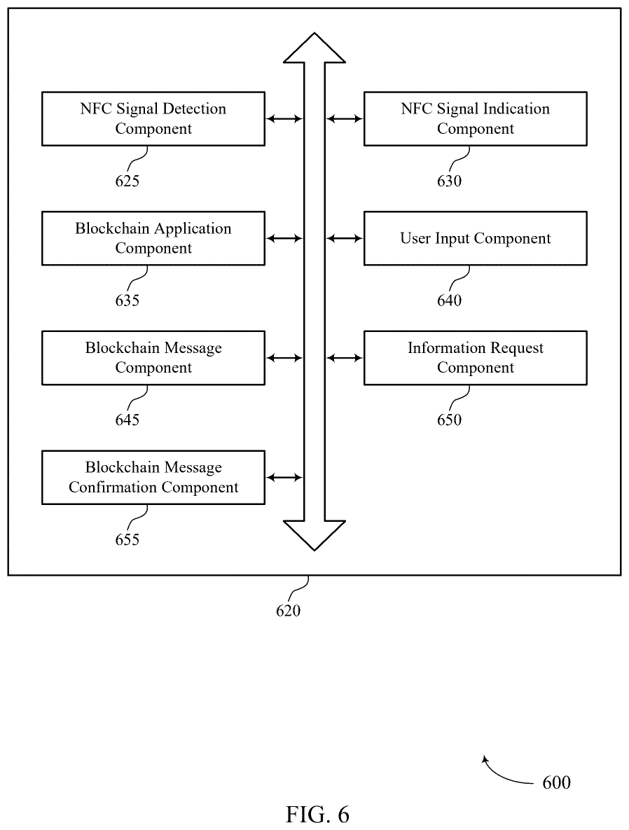

FIG. 6 shows a block diagram 600 of a client application 620 that supports initiating blockchain messages using NFC in accordance with aspects of the present disclosure. The client application 620 may be an example of aspects of a client application or a client application 520, or both, as described herein. The client application 620, or various components thereof, may be an example of means for performing various aspects of initiating blockchain messages using NFC as described herein. For example, the client application 620 may include an NFC signal detection component 625, an NFC signal indication component 630, a blockchain application component 635, a user input component 640, a blockchain message component 645, an information request component 650, a blockchain message confirmation component 655, or any combination thereof. Each of these components, or components of subcomponents thereof (e.g., one or more processors, one or more memories), may communicate, directly or indirectly, with one another (e.g., via one or more buses).

The client application 620 may support digital token management in accordance with examples as disclosed herein. The NFC signal detection component 625 may be configured as or otherwise support a means for detecting, at the user device, a NFC signal transmitted by a receiving device, wherein the NFC signal comprises an indication of a blockchain message configured to transfer, via a blockchain network, an amount of a crypto token to a blockchain address associated with the receiving device. The NFC signal indication component 630 may be configured as or otherwise support a means for displaying an indication of the NFC signal. The blockchain application component 635 may be configured as or otherwise support a means for displaying, based at least in part on receiving first user input associated with the NFC signal, a blockchain address application that comprises a user interface that displays information associated with the blockchain message. The user input component 640 may be configured as or otherwise support a means for receiving, at the blockchain address application, second user input indicating confirmation of the information associated with the blockchain message. The blockchain message component 645 may be configured as or otherwise support a means for transmitting, after receiving the second user input, one or more communications that causes broadcast of the blockchain message via the blockchain network, wherein broadcasting the blockchain message causes transfer of the amount of the crypto token to the blockchain address associated with the receiving device.

In some examples, the indication of the blockchain message comprises an indication of the amount of the crypto token, an indication of one or more products associated with the blockchain message, an indication of the blockchain address associated with the receiving device, a chain identifier associated with the blockchain message, or any combination thereof.

In some examples, the NFC signal detection component 625 may be configured as or otherwise support a means for identifying, within the NFC signal, a deep link that is used to obtain the information associated with the blockchain message, wherein the blockchain address application and the user interface is displayed based at least in part on identifying the deep link within the NFC signal.

In some examples, the information request component 650 may be configured as or otherwise support a means for transmitting, after detecting the NFC signal, receiving the first user input, or both, a request to obtain at least a portion of the information associated with the blockchain message, wherein the request comprises information obtained via the NFC signal. In some examples, the information request component 650 may be configured as or otherwise support a means for receiving the at least the portion of the information after transmitting the request.

In some examples, information associated with the blockchain message that is displayed comprises an indication of the amount of the crypto token, an indication of one or more products associated with the blockchain message, an indication of the blockchain address associated with the receiving device, a network identifier associated with the blockchain message, an address associated with the blockchain address application, or any combination thereof.

In some examples, to support receiving the second user input, the user input component 640 may be configured as or otherwise support a means for receiving a password authentication, a biometric authentication, or any combination thereof.

In some examples, the blockchain message confirmation component 655 may be configured as or otherwise support a means for transmitting, based at least in part on the blockchain message being confirmed on the blockchain network, an indication that the blockchain message is confirmed.

In some examples, the blockchain application component 635 may be configured as or otherwise support a means for triggering, in response to detecting the NFC signal and the blockchain address application being unavailable at the user device, download of the blockchain address application to the user device. In some examples, the blockchain application component 635 may be configured as or otherwise support a means for displaying, via the user interface of the blockchain address application, an indication used to activate purchasing of at least the amount of crypto token, wherein the user interface displaying information associated with the blockchain message is displayed after the at least the amount of the crypto token is purchased.

In some examples, the blockchain application component 635 may be configured as or otherwise support a means for determining that a second amount of crypto token stored in an address associated with the blockchain address application is less than the amount of crypto token. In some examples, the blockchain application component 635 may be configured as or otherwise support a means for displaying, via the user interface of the blockchain address application, an indication used to activate purchasing an additional amount of crypto token, wherein the user interface displaying information associated with the blockchain message is displayed after the additional amount of the crypto token is purchased.

In some examples, to support displaying the indication of the NFC signal, the user input component 640 may be configured as or otherwise support a means for displaying a toast notification associated with detecting the NFC signal, wherein the first user input activates the toast notification and results in display of the blockchain address application and the information associated with the blockchain message.

FIG. 7 shows a diagram of a system 700 including a device 705 that supports initiating blockchain messages using NFC in accordance with aspects of the present disclosure. The device 705 may be an example of or include components of a device 505 as described herein. The device 705 may include components for bi-directional voice and data communications including components for transmitting and receiving communications, such as a client application 720, a communication interface 710, one or more antennas 715, a user interface 725, at least one memory 730, and at least one processor 735. Each of these components may communicate, directly or indirectly, with one another (e.g., via one or more buses, communications links, communications interfaces, or any combination thereof).

The communication interface 710 may manage input and output signals for the device 705 via the antenna 715. For example, the communication interface 710 may enable the user device 705 to exchange information (e.g., input information, output information, or both) with other systems or devices, such as custodial token platform 110 (e.g., supported by one or more servers), via one or more wired or wireless communication links. The communication interface 710 may also utilize or interact with antenna 715 to support communication with other systems or devices. In some cases, the communication interface 710 may represent a physical connection or port to an external peripheral, such as a hardware wallet device. In some cases, the communication interface 710 may utilize an operating system such as iOS®, ANDROID®, MS-DOS®, MS-WINDOWS®, OS/2®, UNIX®, LINUX®, or another known operating system. The communication interface 710 may be implemented as part of the processor 735.

In some cases, the device 705 may include a single antenna 715. However, in some other cases, the device 705 may have more than one antenna 715, which may be capable of concurrently transmitting or receiving multiple wireless transmissions. The communication interface 710 may communicate bi-directionally, via the one or more antennas 715, wired, or wireless links as described herein. For example, the communication interface 710 may represent a wireless transceiver and may communicate bi-directionally with another wireless transceiver. The communication interface 710 may also include a modem to modulate the packets, to provide the modulated packets to one or more antennas 715 for transmission, and to demodulate packets received from the one or more antennas 715.

The user interface 725 may represent interact with a keyboard, a mouse, a touchscreen, a microphone, or a similar device or component. In some cases, a user may interact with the user interface 725. In other cases, the user interface 725 may operate automatically without user interaction. The user interface 725 may display or output information such as information received from other systems or devices or information to be transmitted to other systems or devices.

The memory 730 may include RAM and ROM. The memory 730 may store computer-readable, computer-executable software including instructions that, when executed, cause at least one processor 735 to perform various functions described herein. In some cases, the memory 730 may contain, among other things, a BIOS which may control basic hardware or software operation such as the interaction with peripheral components or devices. The memory 730 may be an example of a single memory or multiple memories. For example, the user device 705 may include one or more memories 730.

The processor 735 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 735 may be configured to operate a memory array using a memory controller. In other cases, a memory controller may be integrated into the processor 735. The processor 735 may be configured to execute computer-readable instructions stored in at least one memory 730 to perform various functions (e.g., functions or tasks supporting a method and system for initiating blockchain messages using NFC). Though a single processor 735 is depicted in the example of FIG. 7, it is to be understood that the user device 705 may include any quantity of one or more of processors 735 and that a group of processors 735 may collectively perform one or more functions ascribed herein to a processor, such as the processor 735. The processor 735 may be an example of a single processor or multiple processors. For example, the device 705 may include one or more processors 735.

The client application 720 may support digital token management in accordance with examples as disclosed herein. For example, the client application 720 may be configured as or otherwise support a means for detecting, at the user device, a NFC signal transmitted by a receiving device, wherein the NFC signal comprises an indication of a blockchain message configured to transfer, via a blockchain network, an amount of a crypto token to a blockchain address associated with the receiving device. The client application 720 may be configured as or otherwise support a means for displaying an indication of the NFC signal. The client application 720 may be configured as or otherwise support a means for displaying, based at least in part on receiving first user input associated with the NFC signal, a blockchain address application that comprises a user interface that displays information associated with the blockchain message. The client application 720 may be configured as or otherwise support a means for receiving, at the blockchain address application, second user input indicating confirmation of the information associated with the blockchain message. The client application 720 may be configured as or otherwise support a means for transmitting, after receiving the second user input, one or more communications that causes broadcast of the blockchain message via the blockchain network, wherein broadcasting the blockchain message causes transfer of the amount of the crypto token to the blockchain address associated with the receiving device.

By including or configuring the client application 720 in accordance with examples as described herein, the device 705 may support techniques for initiating blockchain transactions using NFC signals, which may enable reduced latency and improved coordination between devices.

The client application 720 may include an application (e.g., “app”), program, software, extension, or other component which is configured to facilitate communications with a custodial token platform 110 on a server, one or more nodes of a blockchain network 105, other user devices 705, and other devices or systems. For example, the client application 720 may be an application executable on the user device 705, and the client application 720 may be configured to receive data from a custodial token platform 110, transmit data to the custodial token platform 110, process such data, and cause presentation of such data to a user via a user interface 725. The client application 720 may be an example of a wallet application, a wallet device, or both, and may be associated with a wallet address and may access or use a private key to sign messages to facilitate transfer of crypto tokens, messages, transactions, or the like via a blockchain distributed data store.

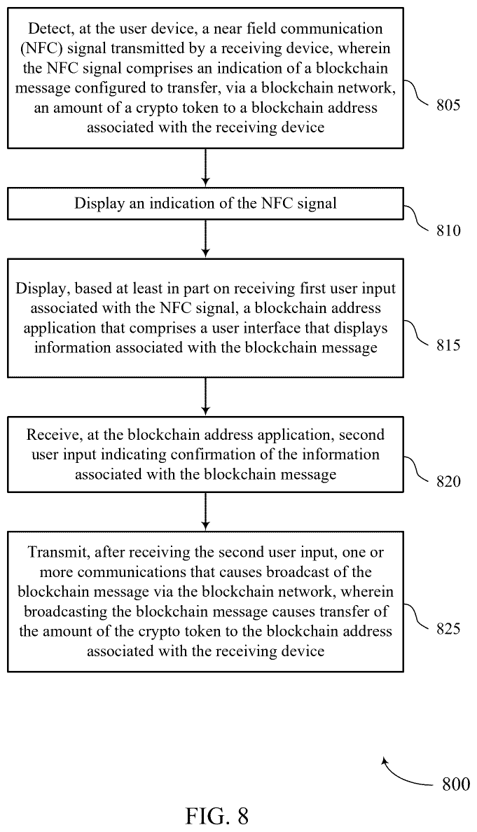

FIG. 8 shows a flowchart illustrating a method 800 that supports initiating blockchain messages using NFC in accordance with aspects of the present disclosure. The operations of the method 800 may be implemented by a user device or its components as described herein. For example, the operations of the method 800 may be performed by a user device as described with reference to FIGS. 1 through 7. In some examples, a user device may execute a set of instructions to control the functional elements of the user device to perform the described functions. Additionally, or alternatively, the user device may perform aspects of the described functions using special-purpose hardware.

At 805, the method may include detecting, at the user device, a NFC signal transmitted by a receiving device, wherein the NFC signal comprises an indication of a blockchain message configured to transfer, via a blockchain network, an amount of a crypto token to a blockchain address associated with the receiving device. The operations of 805 may be performed in accordance with examples as disclosed herein. In some examples, aspects of the operations of 805 may be performed by an NFC signal detection component 625 as described with reference to FIG. 6.

At 810, the method may include displaying an indication of the NFC signal. The operations of 810 may be performed in accordance with examples as disclosed herein. In some examples, aspects of the operations of 810 may be performed by an NFC signal indication component 630 as described with reference to FIG. 6.

At 815, the method may include displaying, based at least in part on receiving first user input associated with the NFC signal, a blockchain address application that comprises a user interface that displays information associated with the blockchain message. The operations of 815 may be performed in accordance with examples as disclosed herein. In some examples, aspects of the operations of 815 may be performed by a blockchain application component 635 as described with reference to FIG. 6.

At 820, the method may include receiving, at the blockchain address application, second user input indicating confirmation of the information associated with the blockchain message. The operations of 820 may be performed in accordance with examples as disclosed herein. In some examples, aspects of the operations of 820 may be performed by a user input component 640 as described with reference to FIG. 6.

At 825, the method may include transmitting, after receiving the second user input, one or more communications that causes broadcast of the blockchain message via the blockchain network, wherein broadcasting the blockchain message causes transfer of the amount of the crypto token to the blockchain address associated with the receiving device.

The operations of 825 may be performed in accordance with examples as disclosed herein. In some examples, aspects of the operations of 825 may be performed by a blockchain message component 645 as described with reference to FIG. 6.

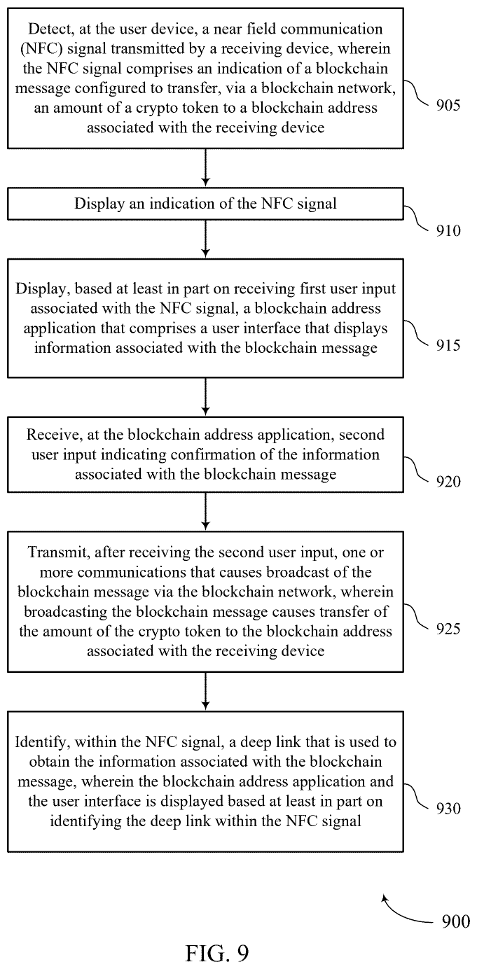

FIG. 9 shows a flowchart illustrating a method 900 that supports initiating blockchain messages using NFC in accordance with aspects of the present disclosure. The operations of the method 900 may be implemented by a user device or its components as described herein. For example, the operations of the method 900 may be performed by a user device as described with reference to FIGS. 1 through 7. In some examples, a user device may execute a set of instructions to control the functional elements of the user device to perform the described functions. Additionally, or alternatively, the user device may perform aspects of the described functions using special-purpose hardware.

At 905, the method may include detecting, at the user device, a NFC signal transmitted by a receiving device, wherein the NFC signal comprises an indication of a blockchain message configured to transfer, via a blockchain network, an amount of a crypto token to a blockchain address associated with the receiving device. The operations of 905 may be performed in accordance with examples as disclosed herein. In some examples, aspects of the operations of 905 may be performed by an NFC signal detection component 625 as described with reference to FIG. 6.

At 910, the method may include displaying an indication of the NFC signal. The operations of 910 may be performed in accordance with examples as disclosed herein. In some examples, aspects of the operations of 910 may be performed by an NFC signal indication component 630 as described with reference to FIG. 6.

At 915, the method may include displaying, based at least in part on receiving first user input associated with the NFC signal, a blockchain address application that comprises a user interface that displays information associated with the blockchain message. The operations of 915 may be performed in accordance with examples as disclosed herein. In some examples, aspects of the operations of 915 may be performed by a blockchain application component 635 as described with reference to FIG. 6.

At 920, the method may include receiving, at the blockchain address application, second user input indicating confirmation of the information associated with the blockchain message. The operations of 920 may be performed in accordance with examples as disclosed herein. In some examples, aspects of the operations of 920 may be performed by a user input component 640 as described with reference to FIG. 6.

At 925, the method may include transmitting, after receiving the second user input, one or more communications that causes broadcast of the blockchain message via the blockchain network, wherein broadcasting the blockchain message causes transfer of the amount of the crypto token to the blockchain address associated with the receiving device. The operations of 925 may be performed in accordance with examples as disclosed herein. In some examples, aspects of the operations of 925 may be performed by a blockchain message component 645 as described with reference to FIG. 6.

At 930, the method may include identifying, within the NFC signal, a deep link that is used to obtain the information associated with the blockchain message, wherein the blockchain address application and the user interface is displayed based at least in part on identifying the deep link within the NFC signal. The operations of 930 may be performed in accordance with examples as disclosed herein. In some examples, aspects of the operations of 930 may be performed by an NFC signal detection component 625 as described with reference to FIG. 6.

A method for digital token management by a user device is described. The method may include detecting, at the user device, a NFC signal transmitted by a receiving device, wherein the NFC signal comprises an indication of a blockchain message configured to transfer, via a blockchain network, an amount of a crypto token to a blockchain address associated with the receiving device, displaying an indication of the NFC signal, displaying, based at least in part on receiving first user input associated with the NFC signal, a blockchain address application that comprises a user interface that displays information associated with the blockchain message, receiving, at the blockchain address application, second user input indicating confirmation of the information associated with the blockchain message, and transmitting, after receiving the second user input, one or more communications that causes broadcast of the blockchain message via the blockchain network, wherein broadcasting the blockchain message causes transfer of the amount of the crypto token to the blockchain address associated with the receiving device.

A user device for digital token management is described. The user device may include one or more memories storing processor executable code, and one or more processors coupled with the one or more memories. The one or more processors may individually or collectively be operable to execute the code to cause the user device to detect, at the user device, a NFC signal transmitted by a receiving device, wherein the NFC signal comprises an indication of a blockchain message configured to transfer, via a blockchain network, an amount of a crypto token to a blockchain address associated with the receiving device, display an indication of the NFC signal, display, based at least in part on receiving first user input associated with the NFC signal, a blockchain address application that comprises a user interface that displays information associated with the blockchain message, receive, at the blockchain address application, second user input indicating confirmation of the information associated with the blockchain message, and transmit, after receiving the second user input, one or more communications that causes broadcast of the blockchain message via the blockchain network, wherein broadcasting the blockchain message causes transfer of the amount of the crypto token to the blockchain address associated with the receiving device.

Another user device for digital token management is described. The user device may include means for detecting, at the user device, a NFC signal transmitted by a receiving device, wherein the NFC signal comprises an indication of a blockchain message configured to transfer, via a blockchain network, an amount of a crypto token to a blockchain address associated with the receiving device, means for displaying an indication of the NFC signal, means for displaying, based at least in part on receiving first user input associated with the NFC signal, a blockchain address application that comprises a user interface that displays information associated with the blockchain message, means for receiving, at the blockchain address application, second user input indicating confirmation of the information associated with the blockchain message, and means for transmitting, after receiving the second user input, one or more communications that causes broadcast of the blockchain message via the blockchain network, wherein broadcasting the blockchain message causes transfer of the amount of the crypto token to the blockchain address associated with the receiving device.

A non-transitory computer-readable medium storing code for digital token management is described. The code may include instructions executable by one or more processors to detect, at the user device, a NFC signal transmitted by a receiving device, wherein the NFC signal comprises an indication of a blockchain message configured to transfer, via a blockchain network, an amount of a crypto token to a blockchain address associated with the receiving device, display an indication of the NFC signal, display, based at least in part on receiving first user input associated with the NFC signal, a blockchain address application that comprises a user interface that displays information associated with the blockchain message, receive, at the blockchain address application, second user input indicating confirmation of the information associated with the blockchain message, and transmit, after receiving the second user input, one or more communications that causes broadcast of the blockchain message via the blockchain network, wherein broadcasting the blockchain message causes transfer of the amount of the crypto token to the blockchain address associated with the receiving device.

In some examples of the method, user devices, and non-transitory computer-readable medium described herein, the indication of the blockchain message comprises an indication of the amount of the crypto token, an indication of one or more products associated with the blockchain message, an indication of the blockchain address associated with the receiving device, a chain identifier associated with the blockchain message, or any combination thereof.

Some examples of the method, user devices, and non-transitory computer-readable medium described herein may further include operations, features, means, or instructions for identifying, within the NFC signal, a deep link that may be used to obtain the information associated with the blockchain message, wherein the blockchain address application and the user interface may be displayed based at least in part on identifying the deep link within the NFC signal.

Some examples of the method, user devices, and non-transitory computer-readable medium described herein may further include operations, features, means, or instructions for transmitting, after detecting the NFC signal, receiving the first user input, or both, a request to obtain at least a portion of the information associated with the blockchain message, wherein the request comprises information obtained via the NFC signal and receiving the at least the portion of the information after transmitting the request.

In some examples of the method, user devices, and non-transitory computer-readable medium described herein, information associated with the blockchain message that may be displayed comprises an indication of the amount of the crypto token, an indication of one or more products associated with the blockchain message, an indication of the blockchain address associated with the receiving device, a network identifier associated with the blockchain message, an address associated with the blockchain address application, or any combination thereof.

In some examples of the method, user devices, and non-transitory computer-readable medium described herein, receiving the second user input may include operations, features, means, or instructions for receiving a password authentication, a biometric authentication, or any combination thereof.

Some examples of the method, user devices, and non-transitory computer-readable medium described herein may further include operations, features, means, or instructions for transmitting, based at least in part on the blockchain message being confirmed on the blockchain network, an indication that the blockchain message may be confirmed.

Some examples of the method, user devices, and non-transitory computer-readable medium described herein may further include operations, features, means, or instructions for triggering, in response to detecting the NFC signal and the blockchain address application being unavailable at the user device, download of the blockchain address application to the user device and displaying, via the user interface of the blockchain address application, an indication used to activate purchasing of at least the amount of crypto token, wherein the user interface displaying information associated with the blockchain message may be displayed after the at least the amount of the crypto token may be purchased.

Some examples of the method, user devices, and non-transitory computer-readable medium described herein may further include operations, features, means, or instructions for determining that a second amount of crypto token stored in an address associated with the blockchain address application may be less than the amount of crypto token and displaying, via the user interface of the blockchain address application, an indication used to activate purchasing an additional amount of crypto token, wherein the user interface displaying information associated with the blockchain message may be displayed after the additional amount of the crypto token may be purchased.

In some examples of the method, user devices, and non-transitory computer-readable medium described herein, displaying the indication of the NFC signal may include operations, features, means, or instructions for displaying a toast notification associated with detecting the NFC signal, wherein the first user input activates the toast notification and results in display of the blockchain address application and the information associated with the blockchain message.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for digital token management at a user device, comprising:
detecting, at the user device, a near field communication (NFC) signal transmitted by a receiving device, wherein the NFC signal comprises blockchain message information associated with a blockchain message that is to transfer, via a blockchain network, an amount of a crypto token to a blockchain address associated with the receiving device;
displaying, based at least in part on detecting the NFC signal, a notification message that prompts user action associated with the NFC signal;
receiving, via the displayed notification message, a first user input that causes the user device to launch a blockchain address application;
displaying, via the blockchain address application and based at least in part on receiving the first user input, a user interface that prompts for user confirmation and that displays the blockchain message information obtained via the NFC signal;
receiving, at the blockchain address application, a second user input that confirms the blockchain message information; and
transferring, via a plurality of computing nodes that support the blockchain network, based at least in part on receiving the second user input, and using the blockchain message, the amount of the crypto token to the blockchain address associated with the receiving device.

2. The method of claim 1, wherein the blockchain message information comprises the amount of the crypto token, one or more products associated with the blockchain message, the blockchain address associated with the receiving device, a chain identifier associated with the blockchain message, or any combination thereof.

3. The method of claim 1, further comprising:
identifying, within the NFC signal, a deep link; and
obtaining, using the deep link, the blockchain message information, wherein the the user interface is displayed based at least in part on obtaining the blockchain message information via the deep link within the NFC signal.

4. The method of claim 1, further comprising:
transmitting, after detecting the NFC signal, receiving the first user input, or both, a request to obtain at least a portion of the blockchain message information, wherein the request comprises information obtained via the NFC signal; and
receiving the at least the portion of the blockchain message information after transmitting the request.

5. The method of claim 1, wherein displaying the user interface comprises:
displaying, via the user interface, the amount of the crypto token, one or more products associated with the blockchain message, the blockchain address associated with the receiving device, a network identifier associated with the blockchain message, an address associated with the blockchain address application, or any combination thereof, wherein the second user input confirms the displayed blockchain message information.

6. The method of claim 1, wherein receiving the second user input comprises:
receiving a password authentication, a biometric authentication, or any combination thereof.

7. The method of claim 1, further comprising:
transmitting, based at least in part on the blockchain message being confirmed on the blockchain network and to the receiving device, a confirmation message that causes the receiving device to close a flow associated with the transfer.

8. The method of claim 1, further comprising:
triggering, in response to detecting the NFC signal and the blockchain address application being unavailable at the user device, download of the blockchain address application to the user device; and
displaying, via the user interface of the blockchain address application, a selectable option that prompts the user device to initiate purchasing of at least the amount of crypto token, wherein the user interface displaying information associated with the blockchain message is displayed after completion of the purchasing.

9. The method of claim 1, further comprising:
determining that a second amount of crypto token stored in an address associated with the blockchain address application is less than the amount of crypto token; and
displaying, via the user interface of the blockchain address application, a selectable option that prompts the user device to initiate purchasing an additional amount of crypto token, wherein the user interface displaying information associated with the blockchain message is displayed after completion of the purchasing.

10. The method of claim 1, wherein displaying the notification message comprises:
displaying a toast notification based at least in part on detecting the NFC signal, wherein receiving the first user input comprises:
receiving the first user input that activates the toast notification and causes the user device to launch the blockchain address application and display the blockchain message information.

11. A user device for digital token management, comprising:
one or more memories storing processor-executable code; and
one or more processors coupled with the one or more memories and individually or collectively operable to execute the code to cause the user device to:
detect, at the user device, a near field communication (NFC) signal transmitted by a receiving device, wherein the NFC signal comprises blockchain message information associated with a blockchain message that is to to transfer, via a blockchain network, an amount of a crypto token to a blockchain address associated with the receiving device;
display, based at least in part on detecting the NFC signal, a notification message that prompts user action associated with NFC signal;
receive, via the displayed notification message, a first user input that causes the user device to launch a blockchain address application;
display, via the blockchain address application and based at least in part on receiving the first user input, user interface that prompts for user confirmation and that displays the blockchain message information obtained via the NFC signal;
receive, at the blockchain address application, a second user input that confirms the blockchain message information; and
transfer, via a plurality of computing nodes that support the blockchain network, based at least in part on receiving the second user input, and using the blockchain message, the amount of the crypto token to the blockchain address associated with the receiving device, wherein one or more communications are transmitted to one or more devices different from the receiving device.

12. The user device of claim 11, wherein the blockchain message information comprises the amount of the crypto token, one or more products associated with the blockchain message, the blockchain address associated with the receiving device, a chain identifier associated with the blockchain message, or any combination thereof.

13. The user device of claim 11, wherein the one or more processors are individually or collectively further operable to execute the code to cause the user device to:
identify, within the NFC signal, a deep link; and
obtain, using the deep link, the blockchain message information, wherein the the user interface is displayed based at least in part on obtaining the blockchain message information via the deep link within the NFC signal.

14. The user device of claim 11, wherein the one or more processors are individually or collectively further operable to execute the code to cause the user device to:
transmit, after detecting the NFC signal, receiving the first user input, or both, a request to obtain at least a portion of the blockchain message information, wherein the request comprises information obtained via the NFC signal; and
receive the at least the portion of the blockchain message information after transmitting the request.

15. The user device of claim 11, wherein, to display the user interface, the one or more processors are individually or collectively further operable to execute the code to cause the user device to:
display, via the user interface, the amount of the crypto token, one or more products associated with the blockchain message, the blockchain address associated with the receiving device, a network identifier associated with the blockchain message, an address associated with the blockchain address application, or any combination thereof, wherein the second user input confirms the displayed blockchain message information.

16. A non-transitory computer-readable medium storing code for digital token management, the code comprising instructions executable by one or more processors to:
detect, at a user device, a near field communication (NFC) signal that is transmitted by a receiving device and that is not transmitted by the user device, wherein the NFC signal comprises blockchain message information associated with a blockchain message that is to transfer, via a blockchain network, an amount of a crypto token to a blockchain address associated with the receiving device;
display, based at least in part on detecting the NFC signal, a notification message that prompts user action associated with the NFC signal;
receive, via the displayed notification message, a first user input that causes the user device to launch a blockchain address application;
display, via the blockchain address application and based at least in part on receiving the first user input, a user interface that prompts for user confirmation and that displays the blockchain message information obtained via the NFC signal;
receive, at the blockchain address application, a second user input that confirms the blockchain message information; and
transfer, via a plurality of computing nodes that support the blockchain network, based at least in part on receiving the second user input, and using the blockchain message, the amount of the crypto token to the blockchain address associated with the receiving device.

17. The non-transitory computer-readable medium of claim 16, wherein the blockchain message information comprises the amount of the crypto token, one or more products associated with the blockchain message, the blockchain address associated with the receiving device, a chain identifier associated with the blockchain message, or any combination thereof.

18. The non-transitory computer-readable medium of claim 16, wherein the instructions are further executable by the one or more processors to:
identify, within the NFC signal, a deep link; and
obtain, using the deep link, the blockchain message information, wherein the user interface is displayed based at least in part on obtaining the blockchain message information via the deep link within the NFC signal.

19. The non-transitory computer-readable medium of claim 16, wherein the instructions are further executable by the one or more processors to:
transmit, after detecting the NFC signal, receiving the first user input, or both, a request to obtain at least a portion of the blockchain message information, wherein the request comprises information obtained via the NFC signal; and
receive the at least the portion of the blockchain message information after transmitting the request.

20. The non-transitory computer-readable medium of claim 16, wherein, to display the user interface, the instructions are further executable by the one or more processors to:
display, via the user interface, the amount of the crypto token, one or more products associated with the blockchain message, the blockchain address associated with the receiving device, a network identifier associated with the blockchain message, an address associated with the blockchain address application, or any combination thereof.
